(19) United States
(12) Patent Application Publication
(10) Pub. No.: US 2003/0017437 A1
(43) Pub. Date: Jan. 23, 2003

(54) Mathematical instructional aid device

(76) Inventor: Kay Perkins Emerson, Woodside, CA (US)

Correspondence Address: GARY CARY WARE & FREIDENRICH LLP, 1755 EMBARCADERO ROAD, PALO ALTO, CA, 94303-3340, US

(21) Appl. No.: 10/170,956

(22) Filed: Jun. 12, 2002

Related U.S. Application Data
(60) Provisional application No. 60/300,180, filed on Jun. 21, 2001.

(51) Int. Cl. G09B 19/02; G09B 23/02

(52) U.S. Cl. 434/188

(57) ABSTRACT

A mathematical instructional aid device for teaching fractions or multiplication, in one embodiment, consists of a circularly shaped base having 12 sections. Each section represents a number from 1 to 12. Each section has within it a number of steps with all the steps of the 12 sections converging to a top most plane. Within each section, each step is spaced from an adjacent step by a number representing a multiple of the base value in the base of each section. Values in steps of different sections are co-planar to assist in understanding the concept of multiplication and fractions.

### TECHNICAL FIELD

The present invention relates to a novel mathematical instructional aid device that assists in teaching the concepts of mathematics to younger children.

### BACKGROUND OF THE INVENTION

The subject of mathematics, especially to the younger children, sometimes brings about anguish and fear. The difficulty of the subject is due in part to it being a highly abstract concept which at a tender age is difficult to grasp. Accordingly, it is one object of the present invention to teach mathematical concepts, in a fun, visual and hands-on manner.

### SUMMARY OF THE INVENTION

A mathematical instructional aid device comprises a plurality of sections having a common base lying in a base plane. Each section has a plurality of steps that are formed in a direction intersecting the base plane. The base of each section represents a number. Each step within a section has a value and is spaced apart from an adjacent step by a multiple of the number represented in the base. The steps of different sections having the same value are coplanar.

### BRIEF DESCRIPTION OF THE DRAWINGS

FIG. 1A is a front, top perspective view of a first embodiment of a mathematical instructional aid device of the present invention.

FIG. 1B is a top view thereof.

FIG. 1C is a front view thereof.

FIG. 1D is a left side view thereof.

FIG. 1E is an exploded view thereof

FIG. 2A is a front, top perspective view of a second embodiment of a mathematical instructional aid device of the present invention.

FIG. 2B is a top view thereof.

FIG. 3A is a front, top perspective view of a third embodiment of a mathematical instructional aid device of the present invention.

FIG. 3B is a top view thereof.

FIG. 3C is a left side view thereof.

FIG. 3D is a right side view thereof.

FIG. 3E is a front view thereof.

FIG. 3F is a r ear view thereof.

FIG. 3G is a bottom view thereof.

FIG. 4A is a front, top perspective view of a fourth embodiment of a mathematical instructional aid device of the present invention.

FIG. 4B is a top view thereof.

FIG. 4C is a left side view thereof.

FIG. 4D is a right side view thereof.

FIG. 4E is a front view thereof.

FIG. 4F is a rear view thereof.

FIG. 5A is a front, top perspective view of a fourth embodiment of a mathematical instructional aid device of the present invention.

FIG. 5B is a top view thereof.

FIG. 5C is a left side view thereof.

FIG. 5D is a right side view thereof.

FIG. 5E is a front view thereof.

FIG. 5F is a rear view thereof.

### DETAILED DESCRIPTION OF THE INVENTION

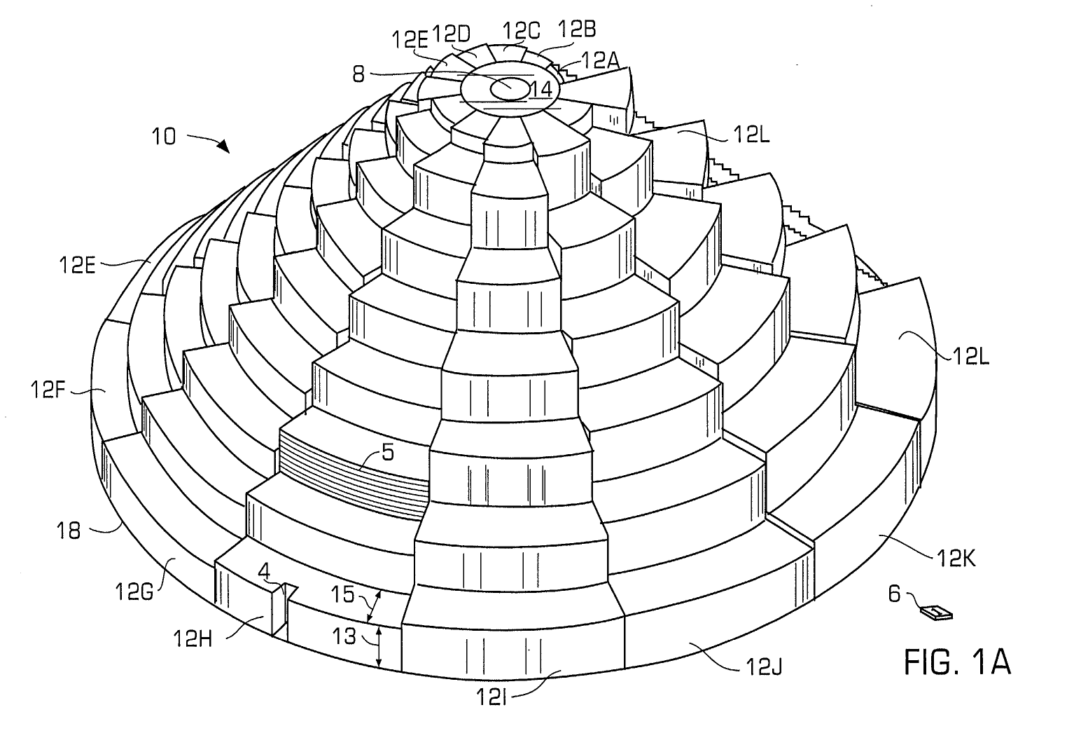

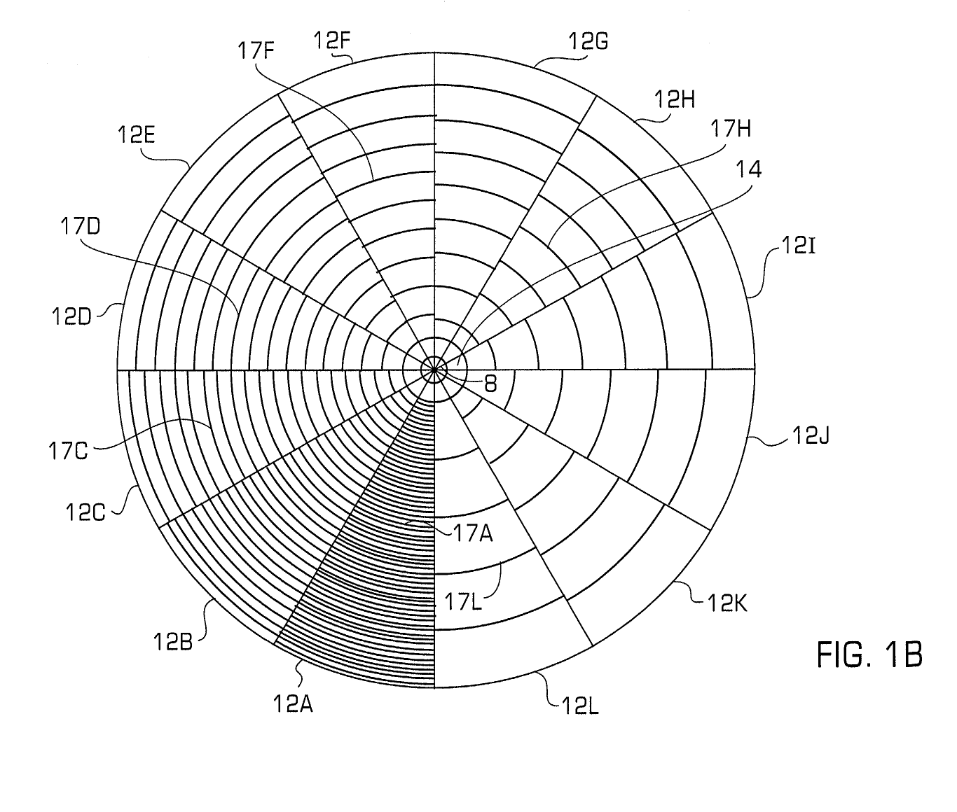

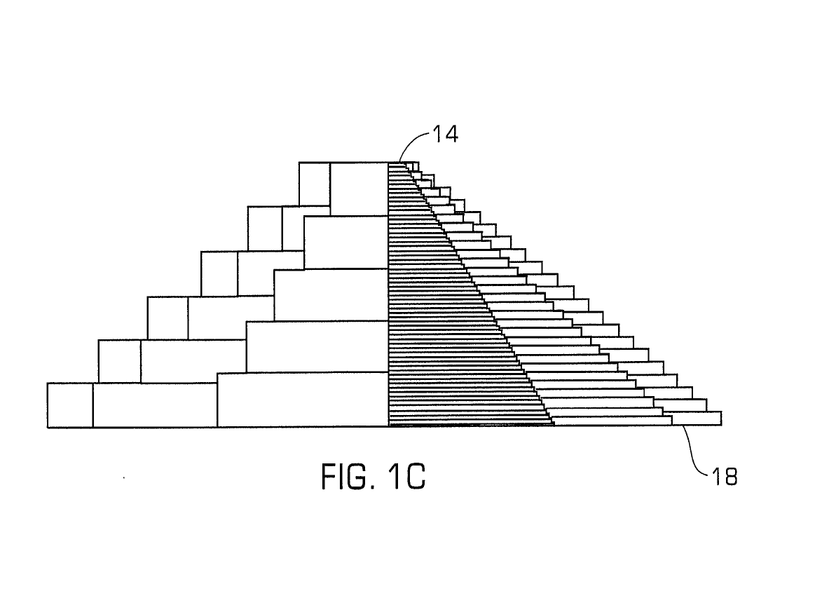

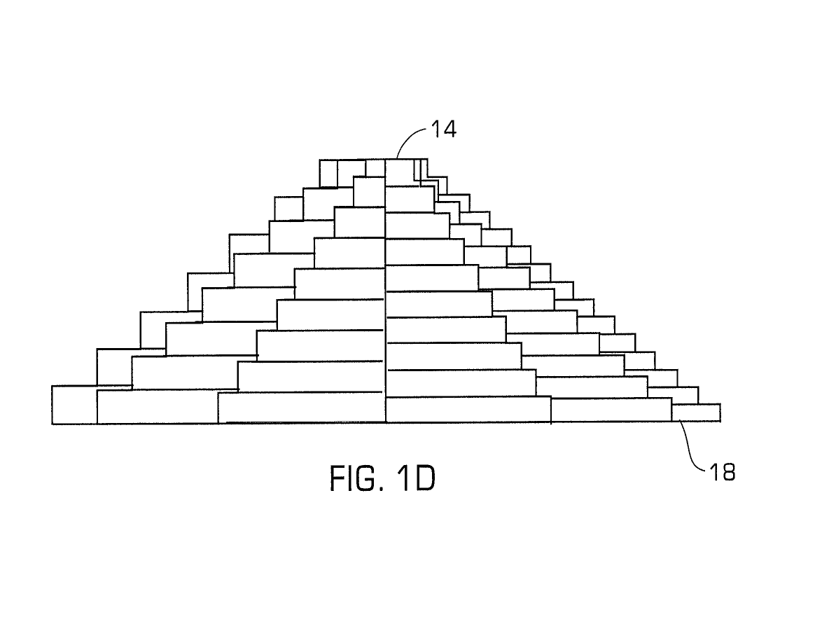

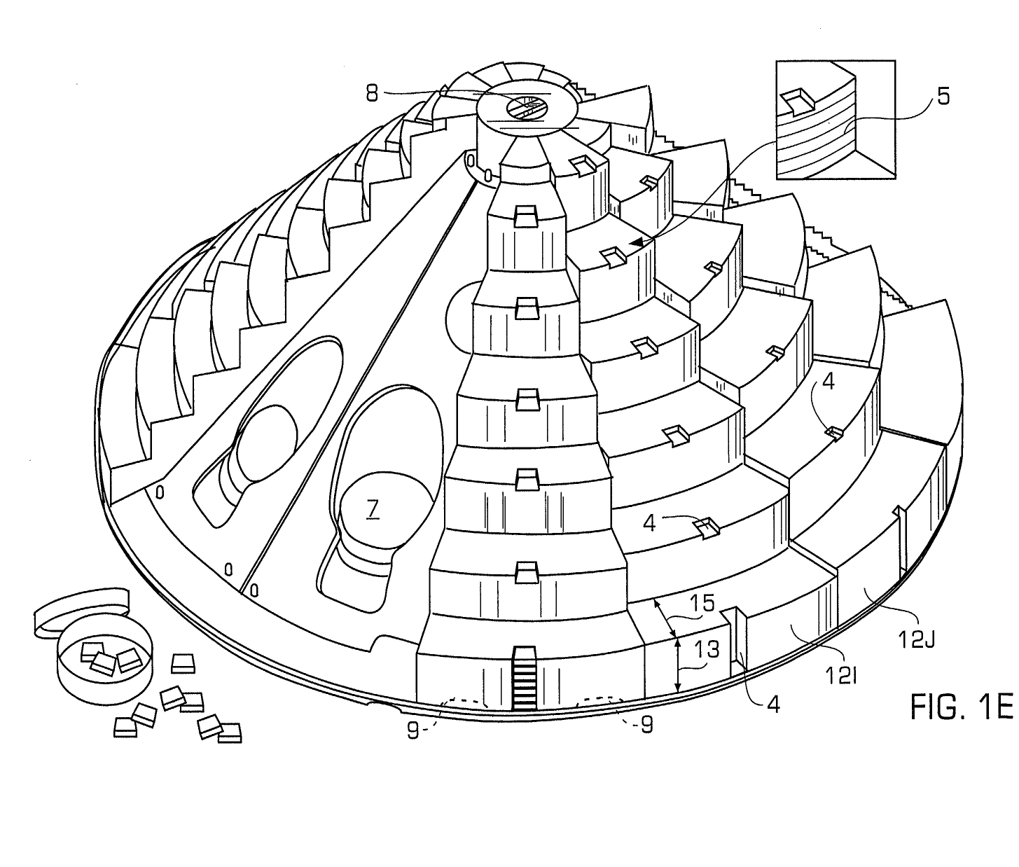

Referring to FIG. 1A, there is shown a perspective view of a first embodiment of a mathematical instructional aid device 10 of the present invention. The device 10 comprises a plurality of connected sections 12(A-L). In the first embodiment shown in FIG. 1A, the sections 12(A-L) are connected together and have a common base 18 that is circular in shape. As shown in FIG. 1A, the preferred embodiment shows twelve (12) sections 12(A-L), which may be constructed as individual components or connected together as one piece. In the preferred embodiment, as shown in FIG. 1E, sections 12(A-L) are individually made and snap onto a circular base, thereby permitting the sections 12(A-L) to be assembled in different order. It will be understood that the number of sections is an arbitrary number since it is the intent of the device 10 to teach a broad range of mathematical concepts for elementary and middle school aged children. All of the sections 12 have a common base lying in a base plane 18. The base plane 18 of the device 10 is circularly shaped. Each section 12 has a plurality of predetermined steps formed in a direction which intersects the base plane. A step has a riser portion 13, shown in section 12H in FIG. 1A, which is perpendicular to the base plane 18 and a tread portion 15 which is parallel to the base plane 18.

The lower most step of each section 12 represents a number. Thus, section 12A in the base thereof can represent the number 1. Section 12B in the base thereof can represent the number 2, etc. Each step within a section 12 has a value that represents a multiple of the number in the base plane 18. Thus, for example, each of the steps in the section 12A represents the value of 1× of the base value 1. Therefore, in the embodiment shown in FIGS. 1A thru 1D, the device 10 would have 60 steps along the section 12A starting from the base plane 18 to the top most plane 14 with all the steps in the section 12 having the same height in the riser portion 13 and the same depth in the tread portion 15. For the section 12B representing a base number of 2, there would be 30 steps from the base plane 18 thereof to the top most plane 14. For the section 12C, since the base number is 3, there would be 20 steps from the base plane 18 of the section 12C to the top most plane 14. Similarly, for section 12D, there would be 15 steps. For section 12E, there would be 12 steps, since section 12E in the base plane represents the number 5. For section 12F, there would be 10 steps, since the base number in section 12F is the number 6. For the section 12G, however, since the value represented in the base plane 18 corresponds to the number 7, there would be 8 steps with a remainder of 4. Since the remainder 4 is less than the numerical spacing between other adjacent steps in section 12G, it is shown in FIG. 1A and in the device 10 as a partial step, having a smaller riser portion 13 than the riser portion 13 of the other steps. All of the other steps in section 12G have the same height in the riser portion 13 representing a multiple of the number in the base plane 18, and the same depth in the tread portion 15. Similarly, for the section 12H, corresponding to the number 8 there would be seven (7) steps with a remainder of 4. There would be a partial step in the last step reaching the top most plane 14. A partial step would also occur in the sections 121, representing the number 9, and 12K, representing the number 11. The partial step would represent the remainders of 6 and 5 respectively. Although remainders are shown as partial steps in this embodiment, it is not necessary to the invention. Alternate embodiments may have sections 12G, 12H, 12I and 12K stop at the last full step, without creating a remainder or partial step to reach the top most plane 14. This would result in a jagged top 14.

It should be noted that in this embodiment of the device 10 the top most plane 14 is shown as being 60 units (or steps) from the base plane in section 12A. Clearly the invention is not so limited and other devices 10 having greater than or fewer than 60 units along section 12A may be used. Further, although the riser portion 13 of each step in the device 10 shown in FIG. 1A is shown as having a “smooth” surface, it is clear that the invention is not so limited. For example, for the steps in sections 12(B-L), the riser portion 13 for the steps in each of those sections may be “notched” (see notch 4) for use with markers 6 which indicate how many section 12A steps are equivalent to one step in each of the sections 12(B-L). In addition, unit lines 5 may be etched or inscribed in the riser portion 13. Each unit line 5 represents the numerical value of 1. Thus, it could be shown that eight markers (see marker 6) scaled to equal the riser portion 13 of one 12A step would be required to build a step the height of 12H. In addition, the device 10 with its base plane 18 may be mounted on a “lazy susan.” This would aid the student to turn the device 10 to visualize all of the sections 12 of the device 10.

A key aspect of teaching the younger minds the relationship of multiplication is the concept that numbers having the same value can be reached via different routes. Thus, steps representing numbers having the same value are co-planar. Therefore, 10 steps from the base within section 12A (where section 12A represents the 1's times table (i.e. 10 steps×1 =10)) corresponds to the number 10 which is co-planar with the step that is 5 steps from the base in section 12B (which represents the 2's times table (i.e. 5 steps×2 =10)). This is graphically shown in FIG. 1B, wherein lines 17L, 17A, 17B, 17C, 17D, 17F, 17H, having the same value of 24 all lie on the same arc. Further, it should be appreciated that within each section 12, the steps also have uniform depth 15 (in addition to height) which is proportional to the number represented by that step which is a multiple of the number in the base. Thus, the depth 15 of steps within each section increases as the number represented by the base increases. For example, a step in section 12J has a greater depth 15 than a step represented in section 12G signifying that the number represented by that step is larger in multiplicative factor of the base value than the number in the section 12G.

In the preferred embodiment, because of manufacturing constraints with injection molding, the cross-section of the steps on each staircase may be trapezoidal in shape rather than square. Thus, the height of the riser portion 13 can be slightly greater than the depth of the tread portion 15. At the bottom of the riser portion 13, the depth of each step is equal or close to the height. At the top of the riser portion 13, the depth of the tread portion 15 of each step can be slightly less than the height of each step because there is a slight draft necessary to remove the plastic part from the injection mold tooling. Therefore, the angle at which the riser portion 13 intersects the base of the step may be slightly less than 90 degrees. And the angle at which the riser portion 13 intersects the tread of the step can also be slightly more than 90 degrees. This draft angle required for the removal of the part is usually between and but is not limited to 1-5 degrees. In actuality, one can not see the dimension where the depth is equal to the height because of the slope of the staircase. Therefore to find this measurement one needs to project the intersection between the line that would be formed if the riser portion 13 was perpendicular to the tread portion 15, tangent to the riser portion 13 at its base. This measurement results in equivalent values being co-planar. In addition, although numbered markers 6 (such as zero (0) to sixty (60)) are disclosed, it is also within the present invention to provide markers that denote mathematical operations or symbols (such as addition (+), subtraction (−), multiplication (×) or division (/)). The markers 6 may be formed by a number of manufacturing means known in the art, including but not limited to die cutting out of foam cards. These foam cards with markers 6 in place are shipped to customers to make sure that all tokens are accounted for. This also allows the user to engage in counting or skip counting exercise, as the markers 6 are removed from the foam card. The device 10 may also have an optional storage container well 8 in the center of the top most plane 14 (called a treasure trove) for game pieces, tokens, stickers, etc. It may be accessed by removing a lid formed by the plane 14 giving access to the recess well 8 formed in the device 10. There may also be optional depressions 7 (shown in FIG. 1E) for separate storage containers under each staircase in the base that holds the staircases. Small plastic jars or containers may be placed in these depressions to hold the loose markers for each staircase. The base may have a number of small depressions 9 in it at the interface between the staircase and the base and at the interface between the markers in the bottom notch of the steps and the base. These are to facilitate the removal of the staircases and/or the markers. The base also may have several notches in the bottom of the base to make it easy to pick up the entire device 10 to move it.

From the foregoing it can be seen that with the device 10 of the present invention, mathematical concepts such as counting and multiplication are visually and intuitively taught. Further, other mathematical concepts that can be taught with the device 10 of the present invention include, but is not limited to odd/even, addition, subtraction, division, remainders, fractions, averages, prime numbers, common denominators, factoring, associative principle, distributive principle, ratios and measurements, introduction to algebra, pattern recognition, and probabilities.

Although the device 10 shown in FIG. 1A is circularly shaped and more particularly is in the shape of a frustum, it is clear that the invention is not so limited. Further, although the device 10 is shown as having a plurality of sections with values that are representative of integers and differing by a value of 1 from an adjacent section, again, the mathematical instructional aid device 10 of the present invention is not so limited. For example, each of the sections 12 can be modular and can be assembled to form a circular device 10 with the sections having different base numbers. A section 12A, representing the base value of 1, can be placed adjacent to a section 12B, representing the base value of 2, which would in turn be placed adjacent to a section 12D, representing the base value of 4. In this manner, the concept of binary numbers and their relationship to one another can be-taught. The sections can be assembled so that base values increase in a clockwise fashion, or a counter clockwise fashion, or sections may be assembled in any other sequence as appropriate for the concepts being taught. Similarly other relationships, such as that between pi and the diameter can be taught.

Further, although each of the sections 12 is shown as being of “solid” construction, the invention is not so limited. The section 12 to hold the steps can be assembled from modular blocks—again to teach the relationship between the steps. In fact, it may be appropriate to have blocks for children to build sections 12 to teach the concept of multiplication as the children builds and learns. In addition, each of the sections 12B-12L may include a means (such as a marker or other modular piece) to provide individual steps on a scale equivalent to the size of each step in section 12A. This means may be a component of each section or it may be an additional piece to be placed on the steps of each section. Finally, although the device 10 is shown as being built of sections 12 that converge from the base plane upward to a top most plane 14, a structure within the scope of the present invention also contemplates a device 10 in which the sections 12 converge from the base plane downward to a lower most plane 14. Such a device may be in the nature of a playground structure upon which children can play and learn.

To further aide in the understanding of the relationship of the numbers represented by the steps of the various sections 12, each section may be colored with a different color. In addition, colored markers may also be used. These color markers may have numbers on them associated with the values of each step in the section so colored. The numbered colored markers would comprise a set of all possible values associated with all steps in the section so colored, thereby teaching the co-planar value/elevation numbers represented by each section 12(A-L). The child can count the steps until the co-planar value is reached. This in turn can be used as a part of a game or classroom exercise.

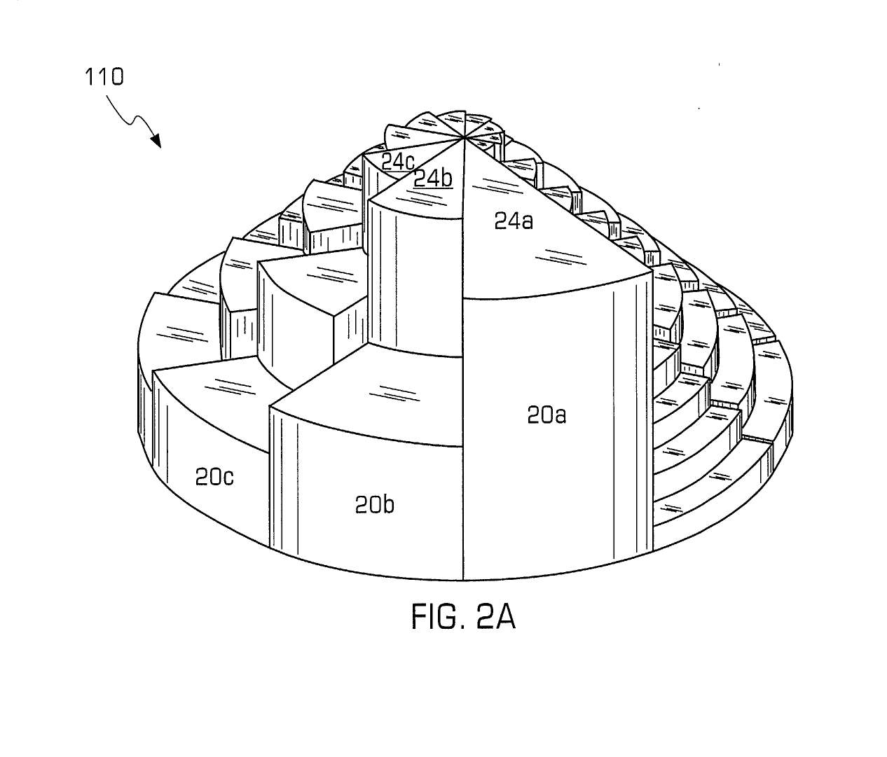

Referring to FIG. 2A, there is shown another device 110 of the present invention which is similar in concept to the device 10 shown in FIG. 1A but is for use in the instruction of fractions. As can be seen in FIG. 2A, the instructional aid device 110 has one section 20A which is substantially pie shaped, representing the value of 1. An adjacent section 20B has two steps therein with each of the steps within section 20B representing the value of ½. The top most plane 24B of the section 20B is co-planar with the top most plane 24A of the section 20A. Again, the device 110 is circularly shaped, having a common circularly shaped base plane.

Another section 20C depicts three steps reaching the top most plane 24C with each step representing the value of ⅓. This continues around the circle for as many fractions as it is desired to teach. In the embodiment shown in FIG. 2A, the instructional aid device 110 has ten sections 20. Therefore, the section 20J has steps representing the value of 1/10. Again, similar to the embodiment shown in FIG. 1, all the steps that have the same value in different sections 20 are co-planar. Further, each step has a height and a depth, with the height and the depth being proportional to the value of the step. Thus, as can be seen in FIG. 2A, the steps of section 20B are taller and deeper (representing the value ½) than the steps shown in section 20C (representing the value of ⅓).

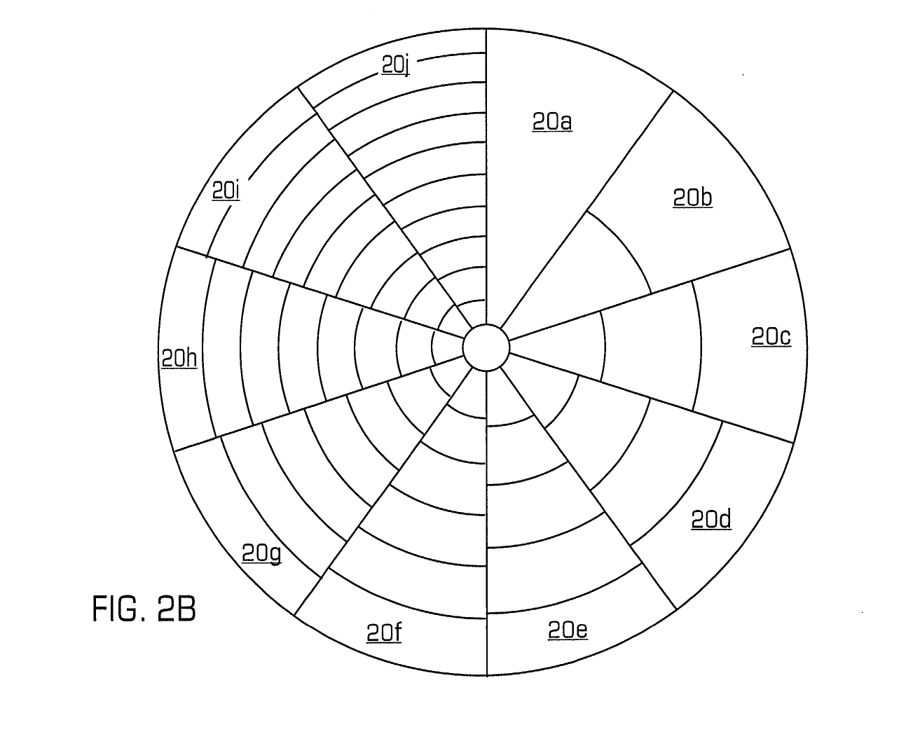

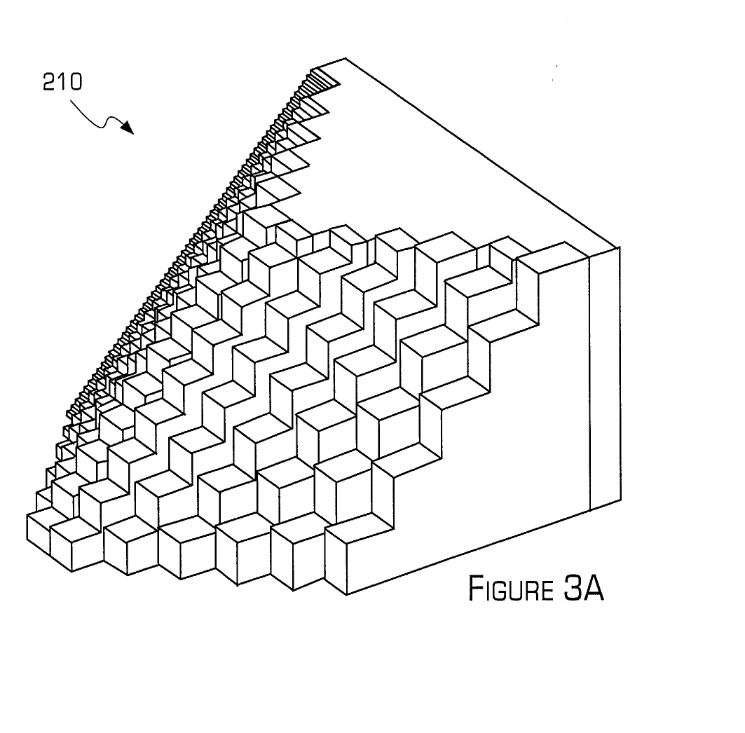

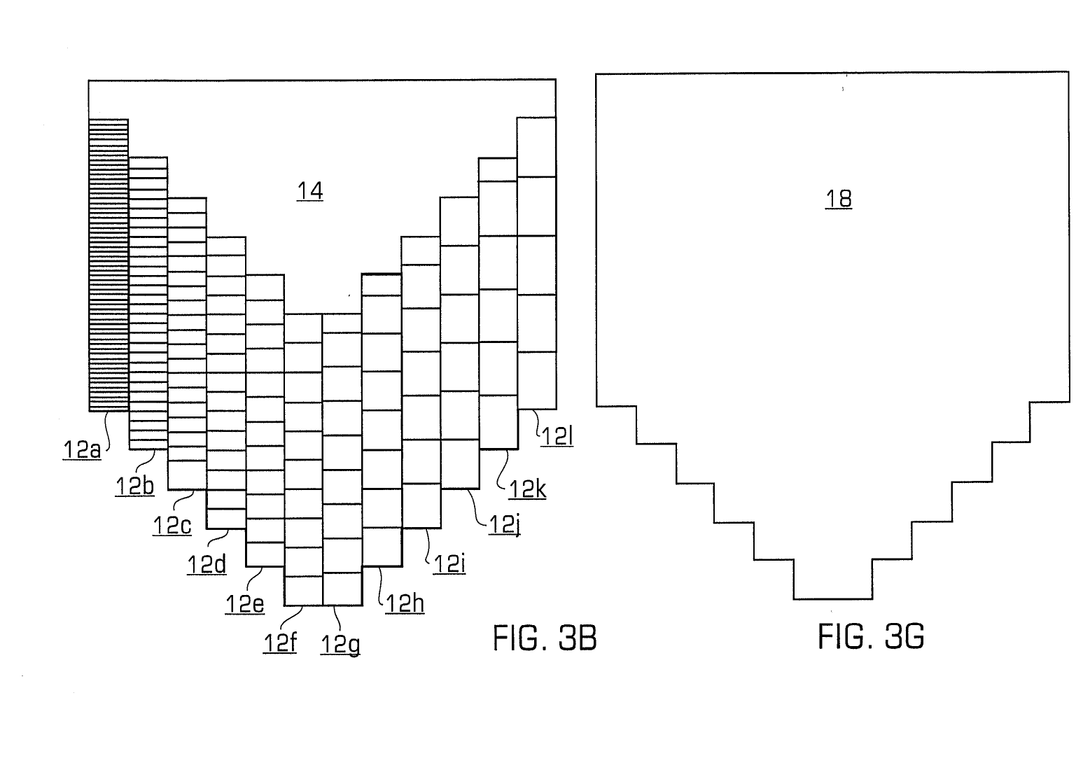

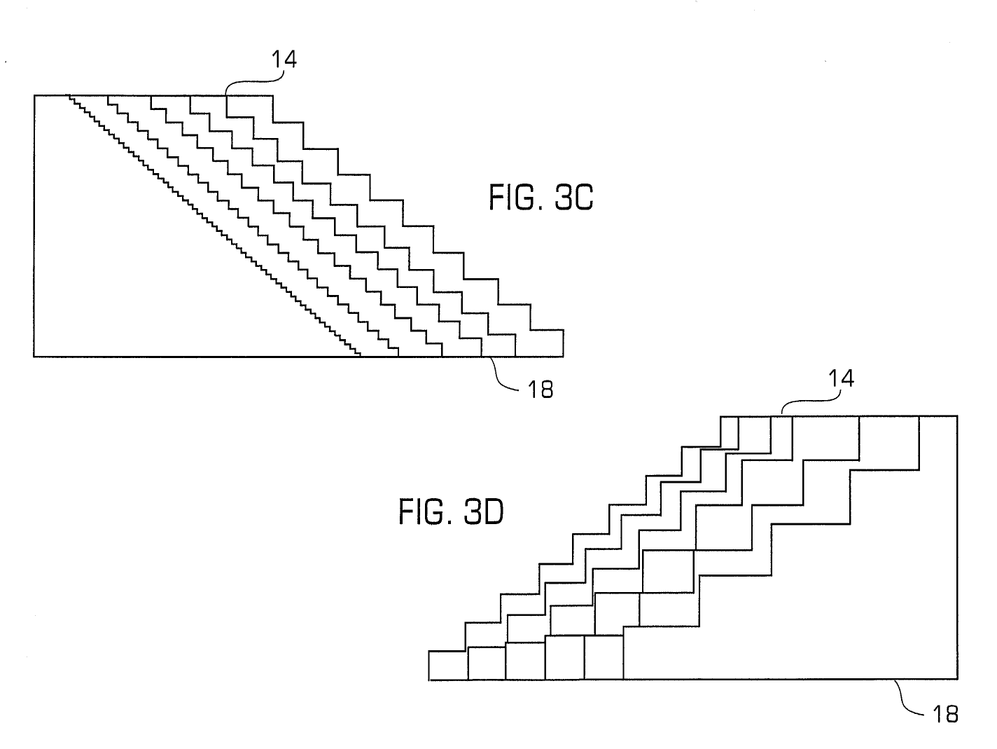

Although the device 10 or 110 or the present invention shown in FIGS. 1A and 2A are circular in shape in a common base plane 18, it need not be so limited. Referring to FIG. 3A, there is shown a third embodiment of a mathematical instructional aid device 210 of the present invention. The device 210, similarly to the device 10 and 110 has a plurality of sections having a common base lying in a base plane 18. The base plane 18 is substantially triangular in shape. However, similar to the embodiment shown in FIG. 1, the device 210 has 12 sections 12(A-L). The numbers in the base plane 18 for each section are the integers 1-12 respectively. All of the sections 12 converge at a top most plane 14 representing the value of 60 as in the device 10 shown in FIG. 1A. Again, similar to the embodiment shown in FIG. 1A, the steps within each section have the same height and depth and represent a multiple of the value represented in the base plane. Further, steps of different sections, representing numbers having the same value, are co-planar. This is graphically shown in FIG. 3E, wherein co-linear lines (representing steps having the same co-planar values) are shown. Finally, partial steps are shown for those sections whose top most step is not an even multiple of the value represented by the top most plane 14, as in section 12G (representing the number 7), section 12I (representing the number 9) and section 12K (representing the number 11). In all other aspects, except for the shape of the base plane, the device 210 is similar to the device 10.

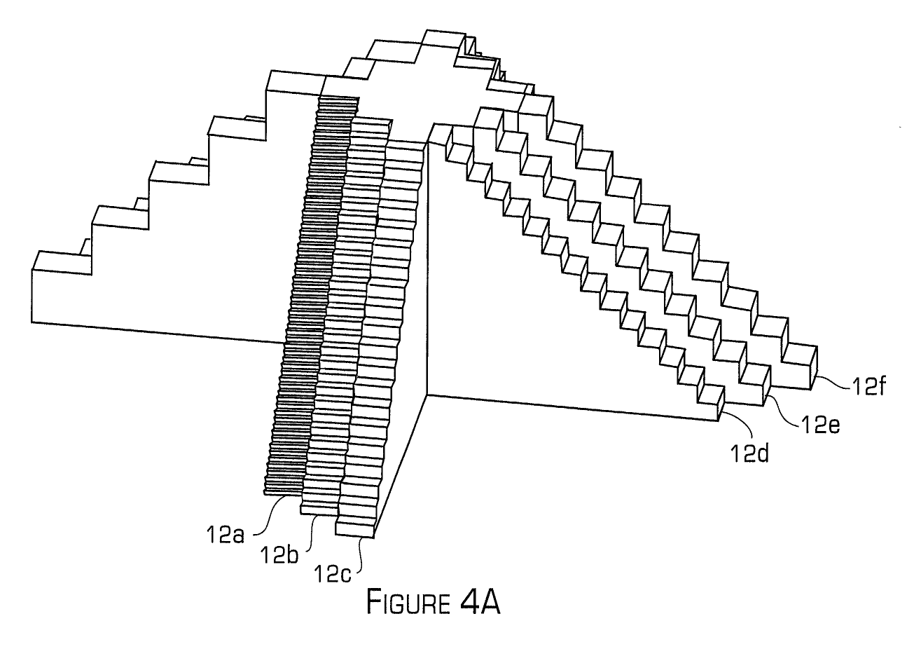

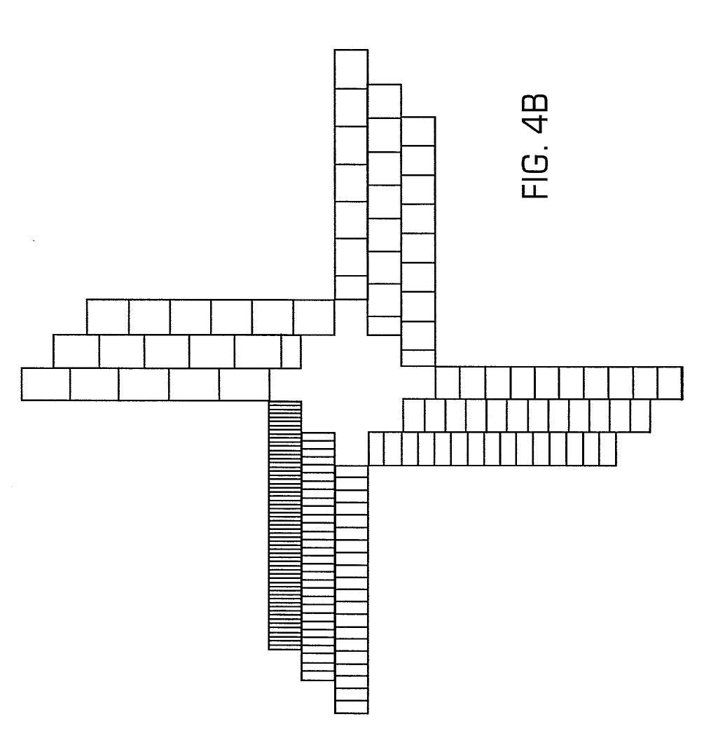

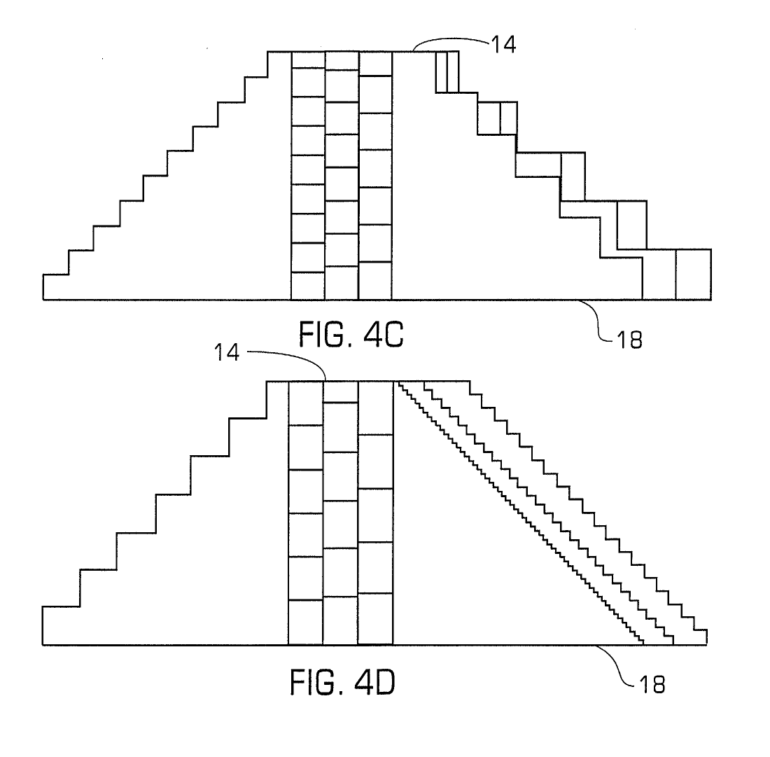

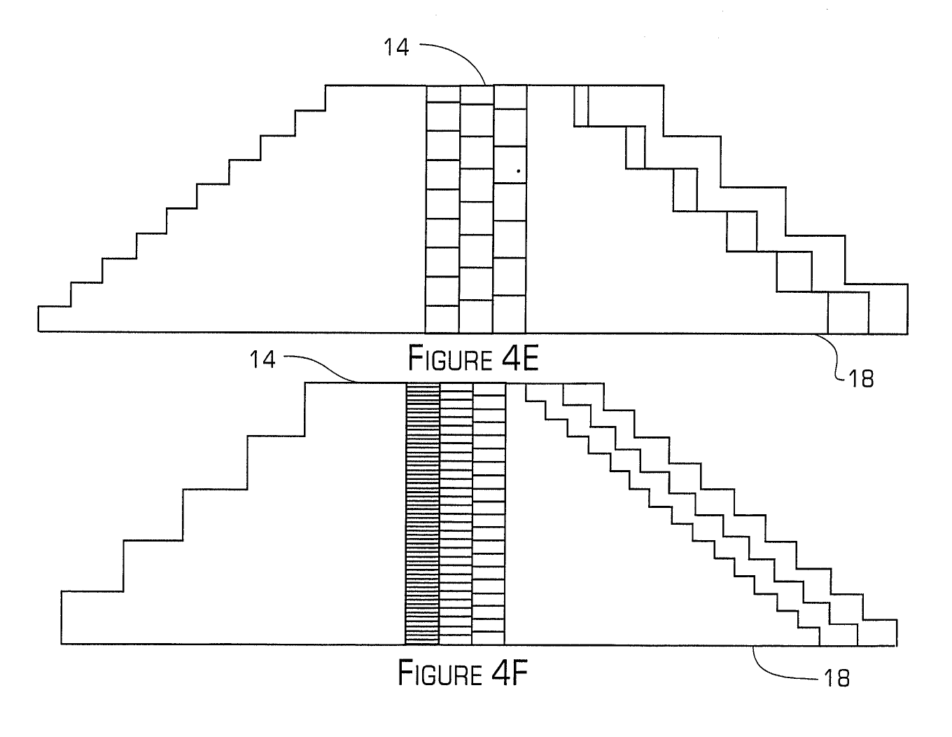

Referring to FIG. 4A, there is shown yet another embodiment of a device 310 of the present invention. The device 310, like the device 10 and 210 has a plurality of sections (12) having a common base lying in a base plane 18, with the numbers in the base of each section 12 representing an integer value. Each section 12 has a plurality of steps formed in a direction intersecting the base plane. Each step has a value and is spaced apart from one another by a distance representing a multiple of the number in the base plane. Further, steps of different sections 12 having the same value are co-planar. Unlike the device 10 and 210, however, the device 310 has a X-shaped base lying in the base plane.

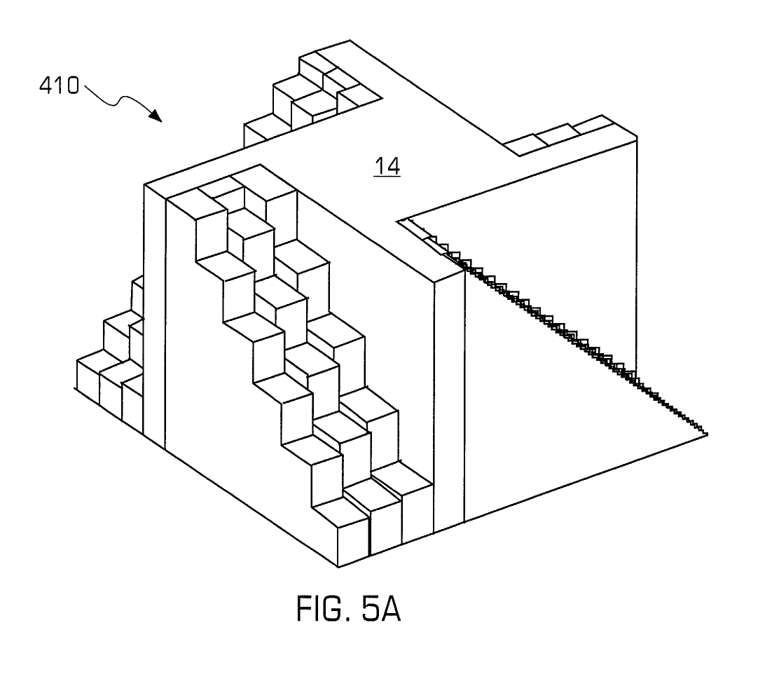

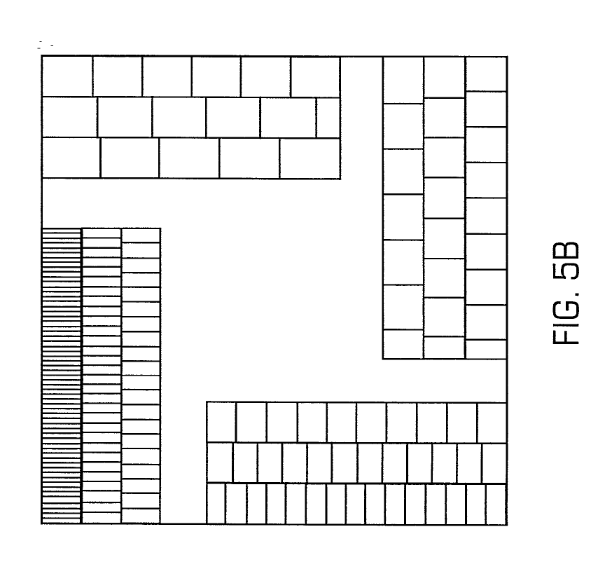

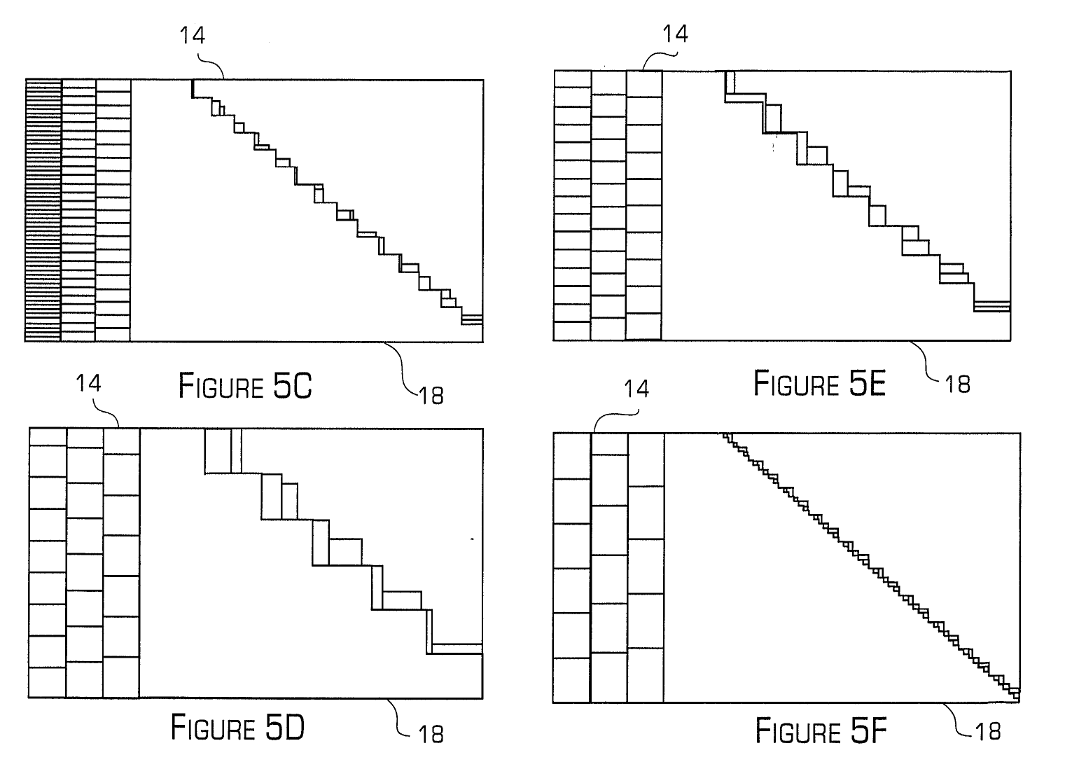

Referring to FIG. 5A, there is shown yet another embodiment of a device 410 of the present invention. The device 410 similar to the device 10, 210 and 310, comprise a plurality of sections 12(A-L) with each section connected and having a common base lying in a base plane 18. The base plane 18 of the device 410 is rectilinearly shaped and can be a rectangle or a square. The steps of the sections 12(A-L) are similar to the steps of the sections shown in the device 10, 210 and 310. Each of the steps within the section has a certain height and depth representing a multiple of the value in the base of the section. Again, similar to the device 10, 210 and 310, steps from different sections 12 having the same value are co-planar. Although devices 210, 310, and 410 are shown with the numbers in the base of each section representing integer values, they need not be so limited. Other embodiments of these devices may have triangular, x-shaped, or square shapes for base plane 18 using fractions instead of integer base values.

Although the devices 10, 110, 210, 310 and 410 are shown as being physical, they can also be generated for display on the monitor of a computer. In that event, the image of the device 10, 110, 210, 310 or 410, can be either two-dimensional or three-dimensional. The images so generated on the computer monitor can be a part of a mathematical game or other instructional program.

Any or all of the embodiments of said devices may have additional graphics or other visual stimuli to aid in the instruction of math concepts. Graphics may include but are not limited to step numbers, co-planar values, base value, and horizontal lines noting unit values on the face of each step.

From the foregoing, it can be seen that a visually instructive mathematical aid device has been disclosed. This mathematical instructional aid device assists in the teaching of the concepts of multiplication and of fractions in a visually stimulating manner.

What is claimed is:

1. A mathematical instructional aide device comprising:
a plurality of sections having a common base lying in a plane; and
each section having a plurality of steps formed in a direction intersecting said plane, wherein the base of each section represents a number with each step having a value and being spaced apart from one another by a distance representing the same multiple of said number;
wherein steps of different sections having the same value are substantially coplanar.

2. The device of claim 1 wherein each section represents an integer number.

3. The device of claim 2 wherein the numbers in the base of each section, represented by two adjacent sections differ by 1.

4. The device of claim 1 wherein each section represents a fractional number.

5. The device of claim 1 wherein said multiple is 1.

6. The device of claim 1 wherein said common base is a circle.

7. The device of claim 1 wherein said device is in the shape of a frustum.

8. The device of claim 1 wherein said common base is rectilinearly shaped.

9. The device of claim 8 wherein said common base is a rectangle.

10. The device of claim 9 wherein said common base is a square.

11. The device of claim 1 wherein said common base is a triangle.

12. The device of claim 1 wherein said common base is x shaped.

13. The device of claim 1 wherein all said steps in each section have the same depth.

14. The device of claim 13 wherein the depth of each step is proportional to the value represented by said step.

15. The device of claim 1 wherein said steps of each section are color coded.

16. The device of claim 1 further comprising a plurality of markers for use with said device, wherein each marker is imprinted with a number or a mathematical symbol.

17. The device of claim 16 wherein each step has a notch for the placement of said markers, with the number of said markers sized to fit in said notch equal to said multiple of said number.

18. The device of claim 1 wherein each step has a riser portion and a depth portion, with the riser portion having unit lines in scribed thereon.

19. A mathematical instructional aide device comprising:
a plurality of sections having a common base lying in a base plane;
each section having a plurality of steps formed in a direction intersecting said plane and reaching a common top plane, wherein the base of each section represents a number;
each step of each section representing a value that is a multiple of said number in the associated base plane, with the steps of each section having the same multiple, each, step further having a height that is proportional to said multiple of said number in the associated base plane; and
wherein 3-D representation of equivalent values are substantially coplanar.

20. The device of claim 19 wherein each step further having a depth proportional to said multiple of said number in said associated base plane.

21. A computer generated display for assisting in the instruction of mathematics, said display comprising:
an image having a plurality of sections having a common base lying in a plane; and
each section having a plurality of steps formed in a direction intersecting said plane, wherein the base of each section represents a number with each step having a value and being spaced apart from one another by a distance representing the same multiple of said number;
wherein steps of different sections having the same value are substantially coplanar.

22. The screen of claim 21 wherein said image is two dimensional.

23. The screen of claim 21 wherein said image is three dimensional.
